(19) United States
(12) Patent Application Publication
(10) Pub. No.: US 2023/0419121 A1
(43) Pub. Date: Dec. 28, 2023

(54) Systems and Methods for Programmatic Labeling of Training Data for Machine Learning Models via Clustering

(71) Applicant: Snorkel AI, Inc., Redwood City, CA (US)

(72) Inventors: Fait Poms, Oakland, CA (US); Naveen Iyer, San Francisco, CA (US); Braden Hancock, Redwood City, CA (US); Roshni Malani, Sunnyvale, CA (US)

(21) Appl. No.: 18/214,024

(22) Filed: Jun. 26, 2023

Related U.S. Application Data
(60) Provisional application No. 63/356,407, filed on Jun. 28, 2022.

(51) Int. Cl. G06N 3/09; G06N 3/0475

(52) U.S. Cl. CPC G06N 3/09; G06N 3/0475

(57) ABSTRACT

Embodiments are directed to an approach to semi-automatically (programmatically) generate labels for data based on implementation of a clustering technique and can be used to implement a form of programmatic labeling to accelerate the development of classifiers and other forms of models. The disclosed methodology is particularly helpful in generating labels or annotations for unstructured data. In some embodiments, the disclosed approach may be used with data in the form of text, images, or other form of unstructured data.

### CROSS REFERENCE TO RELATED APPLICATION

This application claims the benefit of U.S. Provisional Application No. 63/356,407, filed Jun. 28, 2022, entitled “Systems and Methods for Programmatic Labeling of Training Data for Machine Learning Models via Clustering”, the disclosure of which is incorporated, in its entirety by this reference.

### BACKGROUND

Supervised machine learning (ML) is used widely across industries to derive insights from data and support automated decision systems. Supervised ML models are trained by applying an ML algorithm to a labeled training dataset. Each data example (or element, in the form of variables, characteristics, or “features”) in the training dataset is associated with a label (or annotation) that defines how the element should be classified by the trained model. A trained model can operate on a previously unseen data example to generate a predicted label as an output.

The performance of an ML model is heavily dependent on the quality and quantity of training data used to produce it. If the model is trained on a training dataset where a significant portion of the data examples are labeled incorrectly (for example, due to human misinterpretation during the annotation process), then the model will learn to “predict” or infer the wrong labels and be of lower accuracy and quality. Conversely, if an ML model is trained on a large enough quantity of high-quality data, it will generalize better when considering previously unseen data points. Modern deep learning (DL) models require even larger quantities of high-quality training data than traditional ML models, as they rely on learning vector representations of data points in higher dimensional latent spaces.

The conventional process to create labeled training data sets relies on manual annotation, where a human annotator with expertise in the task the trained model is expected to perform reviews each data example and records a training label. As a result, large, high quality training data sets can be time-consuming and expensive to create, particularly for industry applications that rely on proprietary data. This is especially true for data that requires domain expertise to label (such as identifying pathologies in medical images) or data with privacy constraints (such as data in regulated financial industries). In both cases, the set of viable human annotators is limited, and their time can become prohibitively expensive.

Additionally, ML models frequently need to be retrained on new data sets to reflect changes in business objectives or underlying data distributions. For example, a spam email classifier typically needs to be retrained frequently to identify new spam tactics and patterns of threats, which continue to evolve (and often in response to the behavior of deployed versions of spam detectors).

These factors (individually or in combination) may limit the desire or ability to regularly collect or assemble large, high quality training data sets. In turn, this may disincentivize the initial adoption of ML for new use cases, the extension of existing ML use cases, or generating sufficient updates to existing models in production to maintain a desirable level of performance.

An alternative approach to manual annotation is to label data programmatically. In this approach, knowledge that domain experts would use to generate manual labels (such as text patterns or cross-references with knowledge bases) may be encoded (captured) by programming it in the form of a function, termed a labeling function herein. The labeling function or functions are applied to unlabeled data examples, and the outputs are aggregated into a final set of training labels using an algorithm or ruleset. This process is referred to as “weak supervision”.

While this approach can produce large quantities of training data at a lower cost and more quickly than manual approaches, it still requires a development process to create a set of high-quality labeling functions. This can be especially time-intensive when working with large data sets consisting of unstructured data (such as plain text, PDF documents, or HTML web pages, as examples) as the characteristics of the data cannot be meaningfully summarized without additional processing.

Embodiments of the disclosed systems, apparatuses, and methods introduce an approach to semi-automatically generate labels for data based on implementation of a clustering technique and can be used to implement a form of programmatic labeling to accelerate the development of classifiers and other forms of models. The disclosed methodology is particularly helpful in generating labels or annotations for unstructured data.

Embodiments are directed to solving the noted disadvantages of conventional approaches to labeling or annotating data for use in training a machine learning model, either alone or in combination.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

In the context of this disclosure, a classifier is a model or algorithm that is used to segment input data into a category, such as by indicating the likelihood of the presence or absence of some characteristic in the data (where as examples, the data may be text or an image). A classifier may be used to assign an identifying label to a set of input data, where the label may represent a class, category, or characteristic of the data. Classifiers may be used to determine an expected or “predicted” output based on a set of input data. Classifiers may be used in the processing of data sets and may be implemented in the form of trained machine learning (ML) models, deep learning (DL) models, or neural networks. Training requires a set of data items and an associated label or annotation for each data item.

Embodiments of the disclosed systems, apparatuses, and methods introduce an approach to semi-automatically (that is, programmatically) generate labels for data based on implementation of a clustering technique and can be used to implement a form of programmatic labeling to accelerate the development of classifiers and other forms of models. The disclosed methodology is particularly helpful in generating labels or annotations for unstructured data. In some embodiments, the disclosed approach may be used with data in the form of text, images, or other form of unstructured data.

The disclosed methodology is intended to accelerate the development process for programmatic labeling by automatically identifying and visually representing clusters of salient patterns in data sets. In some embodiments, humans with domain knowledge can then review the clusters and use them to programmatically label data.

Embodiments of the disclosure assist in model development by making the labeling of training data faster, while also improving the quality of the resulting training data. Embodiments provide a form of programmatic labeling to transform data labeling from a tedious, static effort done as a precursor to the “real” AI development workflow to a more integrated experience that is central (and crucial) to the end-to-end AI workflow.

In one embodiment, the disclosure is directed to a method for automatically generating labels for a set of data used to train a machine learning model. The method may include one or more of the following steps, stages, processes, functions, or operations:
For an arbitrary dataset, generate one or more real-valued representations for each datapoint using techniques including, but not limited to, text embeddings, image embeddings, or tf-idf (term frequency-inverse document frequency) vectors, as non-limiting examples, and depending on the type or format of the input data;
   Data modalities are turned into a real-valued vector, referred to as an “embedding”. The technique to turn a datapoint into an embedding varies depending on the task, data type, and engineering requirements. For example, for fast text search, tf-idf vectors are sufficient because they are relatively simple to compute compared to generating deep learning embeddings. They are also interpretable because one knows the algorithm that was used to generate the embeddings. However, for tasks that require the accuracy or adaptability of deep learning to unseen words, generating deep learning embeddings is preferable. Similarly, with images, one can either generate a heuristic representation (such as using a Histogram of Oriented Gradients) or use deep learning;
   If multiple representations are generated, then an embodiment may use each of the multiple representations independently to execute the following steps. The type of embedding technique or representation generated may depend on the application or use case under consideration;
Attempt to group (cluster) the datapoints in the dataset using techniques that assign datapoints to the same group if they share one or more similarities. Examples of such assignment algorithms include (but are not limited to) DBSCAN or distance-based hierarchical clustering. The degree of similarity can be measured by the similarity between two embeddings, and/or whether two datapoints share the same ground truth labels;
   The most common similarity metrics are Manhattan distance or Euclidean/Cosine distance, although others exist and may be used. Manhattan distance measures the discrete absolute difference between two quantities, whereas Euclidean distance measures the distance between two points in Euclidean space. Cosine distance measures the angle that separates two vectors;
   For clustering, Euclidean distance is commonly used to determine whether a datapoint is more likely to belong in one cluster over another by measuring the distance between the datapoint and the centroids of the clusters. To measure the similarity between two datapoints, cosine similarity is most commonly used;
Once the datapoints are initially clustered, the process represents each cluster with a unique aggregate of attributes, typically based on attributes of individual data points in the cluster. These attributes may include (but are not limited to) unique aspects of each datapoint;
   Typically, attributes are chosen in a way that reflects the uniqueness of a datapoint for a task. In some cases, the attribute is a randomly generated string of numbers/characters. For example, if two documents in a dataset are different, the approach would choose to represent them with two different unique identifiers. If two images were the same, the approach would represent them with the same unique identifier;
For each cluster, the process then trains a classifier to classify datapoints as residing in the cluster or not residing in the cluster. Datapoints that are already in the cluster are included in the positive training dataset to train the classifier. Datapoints that are not in the cluster are included in the negative training dataset;
   As a non-limiting example, a SVM (Support Vector Machine) may be used as an algorithm to train a classifier or model;
   Note that other approaches may be used for the purpose of classifying a “new” datapoint as belonging to or not belonging to a cluster. These other approaches include (but are not limited to) a centroid+radius approach, or a “bag” of common words (i.e., the use of n-grams as a keyword for a labeling function);
   A classifier is developed for each cluster and used to “predict” if a “new” (previously unseen or unclassified) datapoint belongs in that cluster;
The process then stores the classifier for each cluster in a database for future reference, and associates a classifier with a cluster using the cluster's unique identifier;
For new or previously unclassified datapoints, the process applies the appropriate classifier for each cluster over the datapoints. Each classifier generates a “prediction” or likelihood as to whether the datapoint belongs in the associated cluster. These predictions can be leveraged for use cases including (but not limited to) programmatic labels for training ML models;
   For example, if a new datapoint “belongs” to a particular cluster based on the output of one or more classifiers, then the identifier or an attribute for that cluster can be assigned as a label for that datapoint, and a combination of multiple such labels and datapoints can be used to train a model;
   A more detailed (but non-limiting) example is the following:
      Assume it is desired to classify a set of emails as spam or not spam. The process flow would first cluster the emails, and for each detected cluster, the process would train a classifier to predict whether a given datapoint belongs in the cluster or not by providing a positive training set as points in the cluster, and a negative training set as other points that are not in the cluster. For this example, assume this results in 10 clusters;
      Assign each cluster as either HAM or SPAM depending on how many datapoints in each class are in each cluster (this may be based on a majority or threshold value of the assignment of datapoints in a cluster). One could also ask a user to manually label the clusters for uncertain cases;
      For data in the dataset that is not labeled, the process would then ask each classifier to predict whether the datapoint is in the cluster or not in the cluster. In one example, the threshold value can be set as 0.5 for this task, as it is a binary classification problem. Therefore, the process would generate 10 predictions (HAM, SPAM) for each datapoint;
      The predictions provide weakly supervised labels that may be used downstream in an embodiment of the disclosed system to generate the annotated training data.

In one embodiment, the disclosure is directed to a system for automatically generating labels for a set of data used to train a machine learning model. The system may include a set of computer-executable instructions, a non-transitory computer-readable memory or data storage element in (or on) which the instructions are stored, and an electronic processor or co-processors. When executed by the processor or co-processors, the instructions cause the processor or co-processors (or a device of which they are part) to perform a set of operations that implement an embodiment of the disclosed method or methods.

In one embodiment, the disclosure is directed to one or more non-transitory computer-readable media including a set of computer-executable instructions, wherein when the set of instructions are executed by an electronic processor or co-processors, the processor or co-processors (or a device of which they are part) performs a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a user, a set of users, an entity, a set or category of entities, a set or category of users, a set or category of data, a specific set of documents, an industry, or an organization, for example. Each account may access one or more services, a set of which are instantiated in their account, and which implement one or more of the methods or functions disclosed and/or described herein.

Other objects and advantages of the systems, apparatuses, and methods disclosed may be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) illustrates non-limiting examples of a labeling function for the use case of an email spam detector;

FIG. 1(b) is a flowchart or flow diagram illustrating a method, process, or set of steps, stages, functions, or operations for generating labels or annotations for data used to train a model, in accordance with some embodiments;

FIG. 2 is a diagram illustrating an example of using the processing flow illustrated in FIG. 1(b) to generate labels for a set of datapoints to enable use of the datapoints and labels to train a model;

FIGS. 3 (a) through 3(e) are diagrams illustrating a set of displays or user interfaces that may be presented to a user in some embodiments;

FIGS. 3(f) and 3(g) are diagrams illustrating use of the disclosed clustering approach as part of the programmatic labeling of datapoints and use of the labeled datapoints as training data for a machine learning model, in accordance with some embodiments;

FIGS. 3(h) and 3(i) are diagrams illustrating use of a generative model in combination with a discriminative model as part of a process to generate labels for training a machine learning model, in accordance with some embodiments;

FIG. 4 is a diagram illustrating elements or components that may be present in a computing device, server, or system configured to implement a method, process, function, or operation in accordance with some embodiments; and

FIGS. 5, 6, and 7 are diagrams illustrating an architecture for a multi-tenant or SaaS platform that may be used in implementing an embodiment of the systems, apparatuses, and methods disclosed and/or described herein.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods disclosed and/or described herein may be implemented by a suitable processing element or elements (such as a processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of computer-executable instructions (e.g., software instructions), where the instructions may be stored on (or in) one or more suitable non-transitory data storage elements. In some embodiments, the set of instructions may be conveyed to a user over a network (e.g., the Internet) through a transfer of instructions or an application that executes a set of instructions.

In some embodiments, the systems and methods disclosed herein may provide services through a SaaS or multi-tenant platform. The platform provides access to multiple entities, each with a separate account and associated data storage. Each account may correspond to a user, a set of users, an entity, a set or category of entities, a set or category of users, a set or category of data, a specific set of documents, an industry, or an organization, for example. Each account may access one or more services, a set of which are instantiated in their account, and which implement one or more of the methods or functions described herein.

In some embodiments, one or more of the operations, functions, processes, or methods disclosed herein may be implemented by a specialized form of hardware, such as a programmable gate array or application specific integrated circuit (ASIC). An embodiment of the disclosed methods may be implemented in the form of an application, a sub-routine that is part of a larger application, a “plug-in”, an extension to the functionality of a data processing system or platform, or other suitable form. The following detailed description is, therefore, not to be interpreted in a limiting sense.

Embodiments of the disclosed approach enable the efficient creation and clustering of embeddings generated from a dataset and use of the resulting clusters to programmatically label data. This transforms a large unlabeled and unstructured dataset into labeled training data for use in developing a classifier or other form of model.

Programmatic labeling is an approach to labeling that breaks through a primary bottleneck limiting AI today: creating high-quality training sets in a way that is scalable, adaptable, and governable. A primary difference between manual labeling and programmatic labeling is the type of input that a user provides. With manual labeling, user input comes in the form of individual labels, created one by one. With programmatic labeling, users instead create labeling functions (LF), which capture labeling rationales and can be applied to large amounts of unlabeled data and aggregated to automatically label large training sets.

Labeling functions are essentially programs that encode the rationale behind a labeling decision, whether that be human insight, an existing organizational resource (such as existing noisy labels or legacy models), or in cases disclosed and/or described herein, a portion of the embedding space identified as being correlated with a particular class. This approach leads to multiple benefits over manual labeling, including:
Scalability: Once a user has “written” or defined a labeling function, no additional human effort is required to label the data—be it thousands or millions of data points—resulting in training datasets that are orders of magnitude larger and/or faster to create than those produced via manual labeling;
Adaptability: When requirements change, data drifts, or new error modes are detected, training sets need to be relabeled. With a manual labeling process, this means manually reviewing each affected data point again, multiplying the cost in both time and money to develop and maintain a high-quality model. When a user produces labels programmatically, recreating the training labels is as simple as adding or modifying a small, targeted number of labeling functions and re-executing them, which can occur at computing speed, not human speed;
Governability: When labeling by hand, users leave no record of their thought process behind the labels they provide, making it difficult to audit what their labeling decisions were-both in general and for individual examples. This presents a challenge for compliance, safety, and quality control purposes. With programmatic labeling, each training label can be traced back to specific and inspectable functions. If bias or other undesirable behavior is detected in a model, a user can trace that back to its source (such as one or more labeling functions) and improve or remove them, and then regenerate the model training set programmatically.

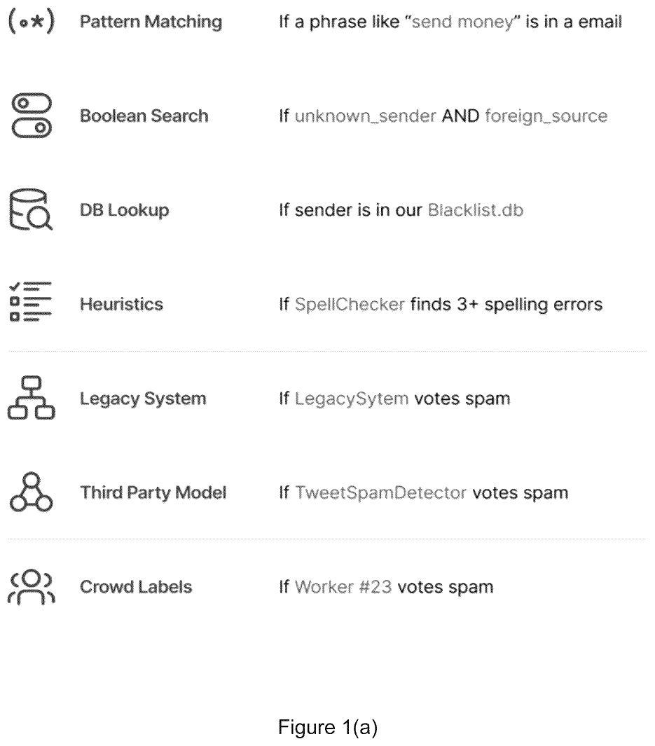

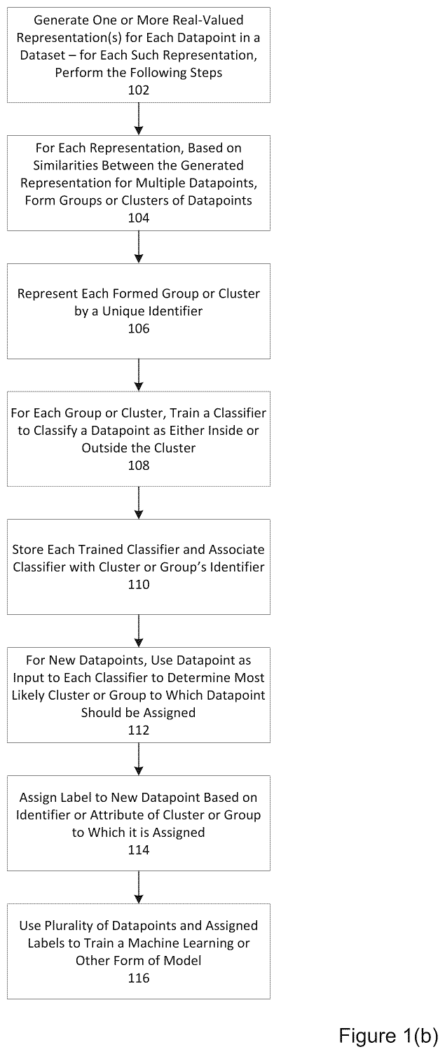

A labeling function may be derived from an array of sources, including heuristics (rules, principles, or patterns, as examples), or existing knowledge resources (models, crowd-sourced labels, or ontologies, as examples). As non-limiting examples, a labeling function may take one or more of the forms illustrated in FIG. 1(a) for the use case of an email spam detector.

Embodiments of the disclosed approach provide several important benefits. These include the ability to explore and understand data more efficiently (even for cold-start problems), based on insight into semantic clustering of data points using embedding techniques. In addition, embodiments make this insight more actionable with programmatic labeling to intelligently auto-label data at scale (as driven by a user's guidance). Further, training data labeling workflows may be accelerated and efficiently scaled using auto-generated cluster labeling functions, which a user can accept and apply with the selection of a user interface element.

In some embodiments, language embedding methods may be used to assist in generating “clusters” of data elements (where the data elements may be words or phrases, field labels, or similar information) that appear to be semantically related. The clusters resulting from a set of training data may vary depending on one or more of (a) the embedding technique used, (b) the metric used to determine similarity for purposes of clustering, or (c) the metric threshold value suggesting that two data elements belong in the same cluster or do not belong in the same cluster (as non-limiting examples). Each cluster may be examined by a user and assigned a “label” for purposes of training a machine learning model. In some embodiments, a proposed label may be generated automatically and presented to the user for their acceptance or rejection. As an example, the label assigned to a cluster may be the one that occurs most frequently for datapoints in a cluster.

Note that although language-based embedding represents one technique for determining relationships between elements of a set of data, other techniques or methods may also (or instead) be used. The chosen technique may depend on the task for which a model is being trained and/or the form of the available datapoints (text or images, as non-limiting examples). In such embodiments, a closeness or similarity metric may be applied to assist in grouping or clustering the output or results of applying the technique. Further, based on the results and a characteristic of the suggested grouping (such as a common category, wording, attribute, or topic, as non-limiting examples), a “label” may be generated and suggested to a user.

A team building a model often needs to work with a dataset that they do not know much about. Together with domain experts, the team members may work through individual documents one-by-one to understand the types of labels to apply to elements of a dataset. For many tasks, this is a prerequisite to establishing a label schema for a project.

As work related to this disclosure has suggested, a helpful strategy is to compute embeddings for the data in a dataset and then use those to identify semantically similar groups (or data that is similar in another sense, such as because of a characteristic of the data). This is especially helpful when a user is not sure where to start with a labeling process. Clustering data using embedding distance (as an example metric) can suggest “natural” groupings to inform how a user might define (or refine) a label schema.

However, while clustering of generated embeddings is a way to orient a user while exploring a dataset, it is typically not actionable beyond that stage. Clusters formed from the embeddings are typically correlated with specific classes (such as topics or categories) but are rarely separable or clean enough for labeling ground truth data in bulk, and with a sufficient degree of reliability to be useful. As an example, a user may still face the task of manually labeling tens or even hundreds of thousands of individual data points to provide sufficient training data for a model. In some cases, a user may be able to outsource the labeling function, or use tooling to marginally accelerate the labeling, but even so, a user is constrained by the time it takes to review and label a large number of documents or other forms of text one at a time.

One reason for this problem is that the data is not easily linearly separable by class. If it were, a user could draw a line to separate two classes and be finished with the process. Instead, data from different classes often mix with each other and require classifiers to help separate them. This is because the data is often complicated, for example images or text, and it is difficult to define rules that distinguish data in one class from another. In addition, exceptions may occur. As a result, it is typically desirable to use a classifier, and in this case, the classifier is a human, and the human is generating a set of ground truth labels.

The disclosed and/or described approach may provide benefits to a user in one or more of the following situations:
Exploring data at varying granularities (e.g., individually or as search results, embedding clusters, or other forms);
Writing no-code Labeling Functions (LFs) using templates in a GUI or custom code LFs in an integrated notebook environment;
Auto-generating LFs based on small, labeled data samples;
Using programmatic active learning to write new LFs for unlabeled or low-confidence data point clusters;
Receiving prescriptive feedback and recommendations to improve existing LFs;
Executing LFs at massive scale over unlabeled data to auto-generate weak labels;
Auto-applying best-in-class label aggregation strategies intelligently selected from a suite of available algorithms based on a dataset's properties;
Training out-of-the-box industry standard models using the resulting training sets more easily in platform, or incorporating custom models via Python SDK;
Performing AutoML searches over hyperparameters and advanced training options;
Engaging in guided and iterative error analysis across both model and data to improve model performance;
Deploying final models as part of larger applications using a chosen production serving infrastructure;
Monitoring model performance overall and on specific dataset slices of interest; and
Adapting more easily to new requirements or data distribution shifts by adjusting labeling functions and regenerating a trained model.

Programmatic labeling can be applied to many types of supervised learning problems. As non-limiting examples, it has been applied to text data (long and short), conversations, time series, PDFs, images, and videos, as well as other forms of data. The disclosed and/or described “labeling function” is flexible enough that the same workflow and framework applies in most cases. As non-limiting examples, potential use cases may include:
Text and/or document classification;
Information extraction from unstructured text, PDF, or HTML;
Rich document processing;
Structured data classification;
Conversational AI and utterance classification;
Entity linking;
Image and cross-modal classification; or
Time series analysis.

FIG. 1(b) is a flowchart or flow diagram illustrating a method, process, or set of steps, stages, functions, or operations for generating labels or annotations for data used to train a model, in accordance with some embodiments. As shown in the figure, the method, process, or set of steps, stages, functions, or operations may include:
Generating One or More Real-Valued Representations for Each Datapoint in a Dataset (as suggested by step or stage 102);
   As disclosed, this may involve a technique chosen based on the type of data and/or the task for which a model is to be trained;
   For each of the generated representations, performing the following steps or stages;
For Each Representation, Based on Similarities Between the Generated Representation for Multiple Datapoints, Forming Groups or Clusters of Datapoints (as suggested by 104);
   Similarity may be based on a chosen metric and a selected threshold value for inclusion or exclusion from a specific cluster;
Representing Each Formed Group or Cluster by a Unique Identifier (step or stage 106);
   The identifier may be selected by reference to a common attribute of the grouped datapoints, as an example;
      In some embodiments, the unique identifier may be generated by a process that determines one or more common features of the grouped datapoints that distinguish them from the members of the other groups or clusters, such as the presence or absence of a characteristic, the presence or absence of a word or phrase, the presence or absence of an object, or a state of a system or process represented by the datapoint;
For Each Group or Cluster, Training a Classifier to Classify a Datapoint as Either Inside or Outside the Cluster (step or stage 108);
   This will result in a set of classifiers, with one corresponding to each of the groups or clusters;
   Each such classifier may be evaluated using a set of datapoints to determine the classifier's accuracy and the utility of the assigned identifier (which may later serve as a label for datapoints assigned to the cluster);
Storing Each Trained Classifier and Associating the Classifier with the Cluster or Group's Identifier (step or stage 110);
For New Datapoints, Using Datapoint as Input to Each Classifier to Determine Most Likely Cluster or Group to Which Datapoint Should be Assigned (step or stage 112);
Assigning a Label to New Datapoint Based on Identifier or Attribute of Cluster or Group to Which it is Assigned (step or stage 114); and
Using a Plurality of Datapoints and Assigned Labels to Train a Machine Learning or Other Form of Model (step or stage 116).

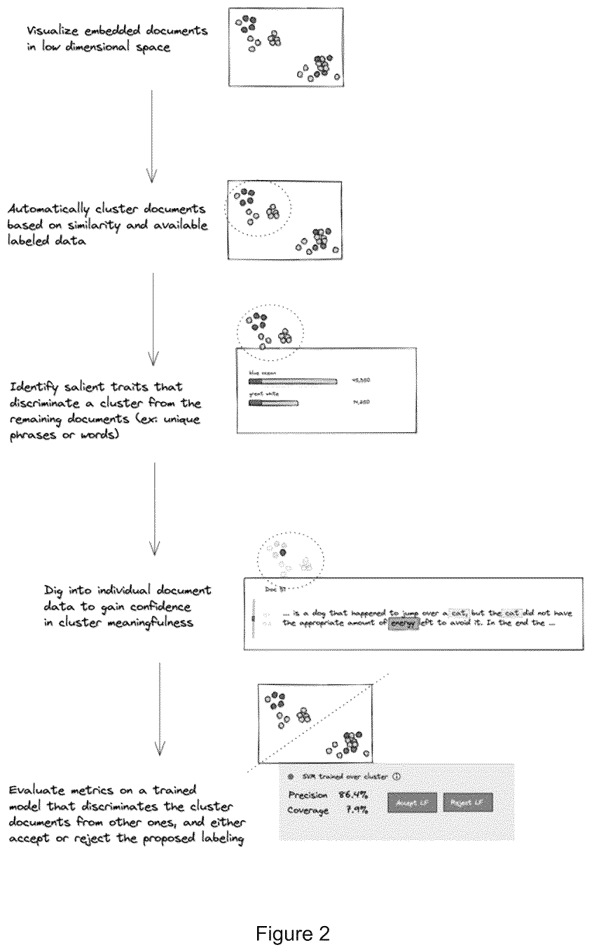

FIG. 2 is a diagram illustrating an example of using the processing flow illustrated in FIG. 1(b) to generate labels for a set of datapoints to enable use of the datapoints and labels to train a model. As shown in the figure, in one example use case, each of a set of documents are processed to generate an embedding representing the document. This is followed by grouping or clustering the set of documents based on a similarity measure or metric. Each such formed group or cluster may then be evaluated to determine a characteristic or attribute that differentiates the members of that group or cluster from the members of the other formed groups or clusters. The contents of one or more datapoints in a cluster may be examined in greater detail to verify the accuracy and usefulness of a cluster identifier. A classifier trained to assign new datapoints as being in or not in a cluster may then be used to evaluate the utility of the assigned identifier by determining the accuracy and effectiveness of the classifier and identifier when applied to new datapoints.

As disclosed, in some embodiments, the process may generate more than a single real-valued representation for each datapoint in a dataset. The technique chosen to generate the representation may be based on the type of data and/or the task for which a model is to be trained. For each of the generated representations, the grouping or clustering, determination of an identifier, training of a classifier, and further described steps are then performed.

Embodiments of the disclosure are directed to systems, apparatuses, and methods for efficiently and reliably generating meaningful labels automatically for a set of training data to be used with a machine learning model. The disclosed approach makes a set of embedding-based clusters derived from a dataset actionable using programmatic labeling assisted by labeling functions. The labeling functions may be programs, logic, algorithms, or heuristics that encode the rationale behind a labeling decision. The labeling decision may be based in whole or in part on human insight, an existing organizational resource (such as existing noisy labels or legacy models), or (as disclosed) a portion of an embedding space identified as being correlated with a particular class or characteristic.

Note that it is not a problem if the labeling functions are noisy, if they label imperfectly, or if they conflict with one another in some places. The disclosed labeling model will intelligently aggregate and reconcile the labels to auto-label training datasets that are larger and have higher quality labels than an individual source would be expected to produce on its own.

Using the disclosed approach (referred to as “Cluster View” herein) creates a new labeling function type. The created function type may be used to capture insights from the embeddings and apply them at scale. This is a powerful method to “warm start” the labeling process and enables a user to label large sections of a dataset, even before training a first model. To accelerate the labeling workflow even further, the disclosed technique can auto-generate a new cluster labeling function using a relatively small amount of ground truth data. From there, a user can accept or reject a labeling function, rather than creating it from scratch. A reason for this behavior is that once the process develops and identifies a group of clusters, the process can use the ground truth labels in each cluster to generate an identifier for a cluster. This results in not needing many of them to make such an inference.

Creating a Cluster View

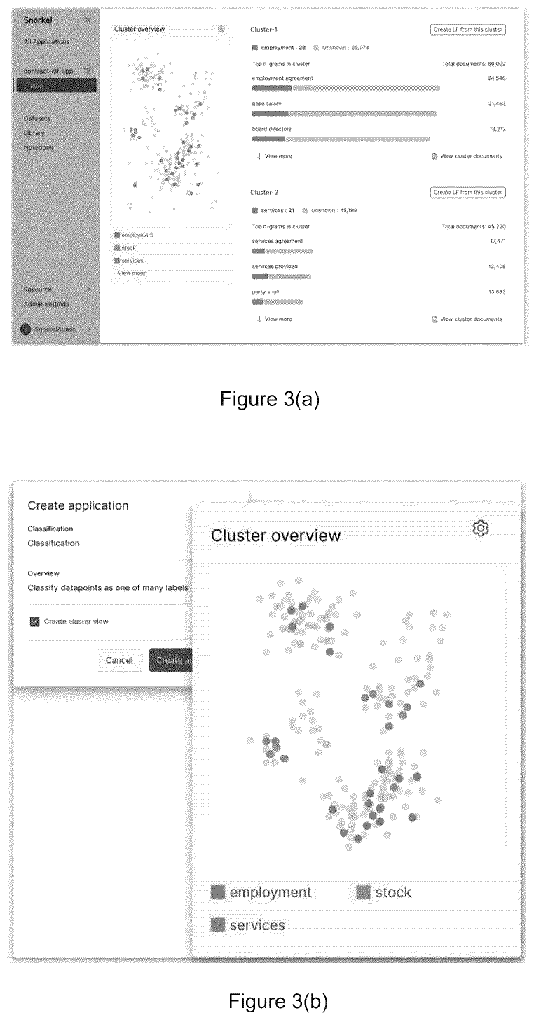

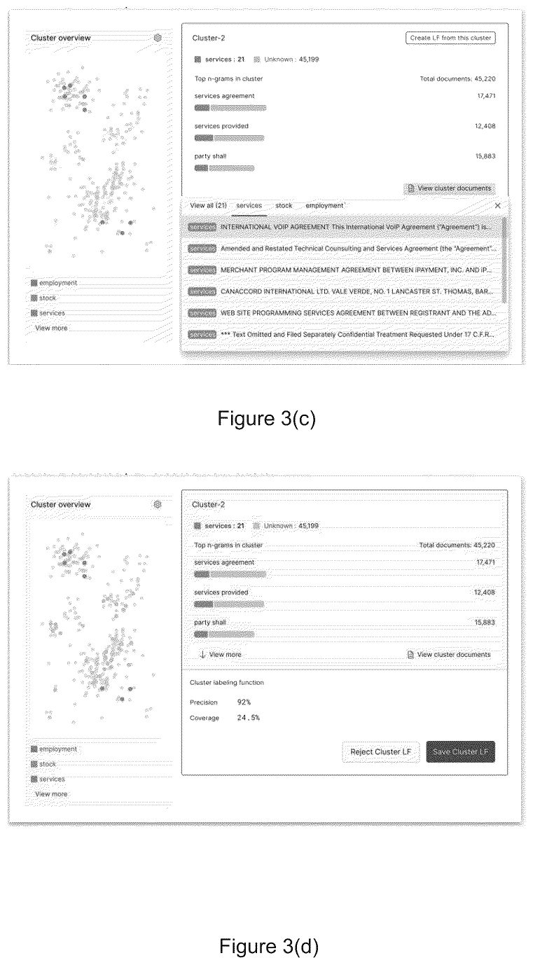

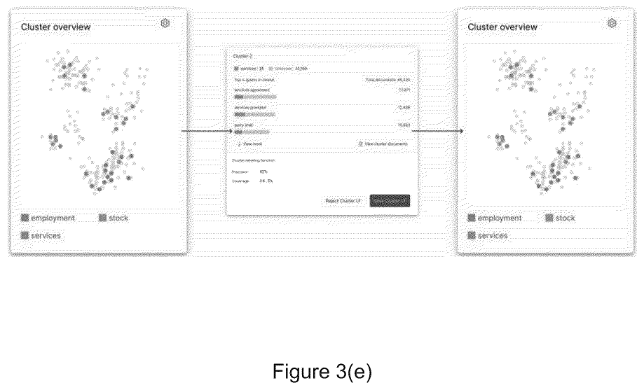

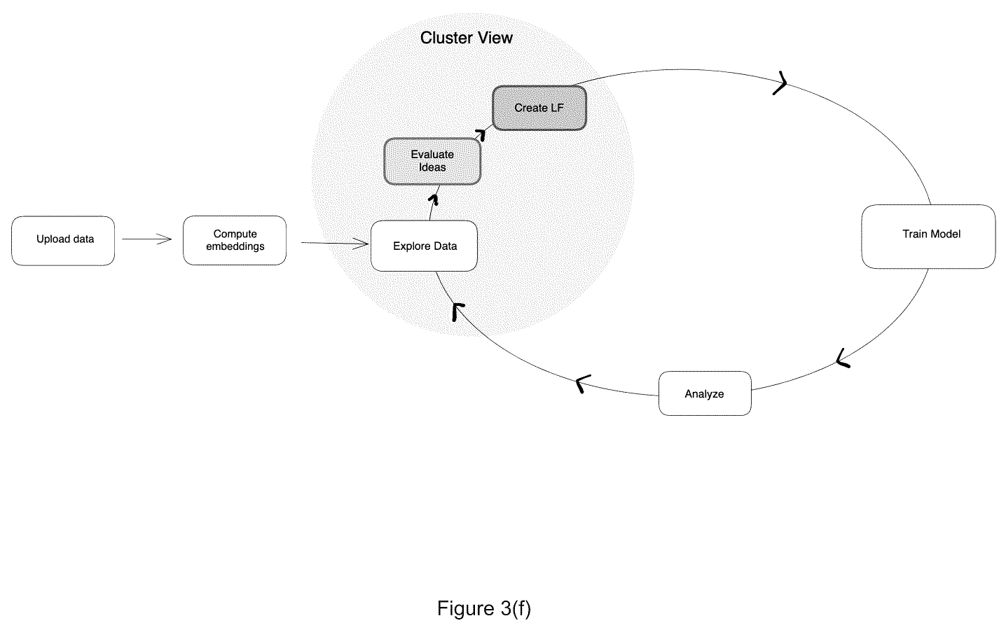

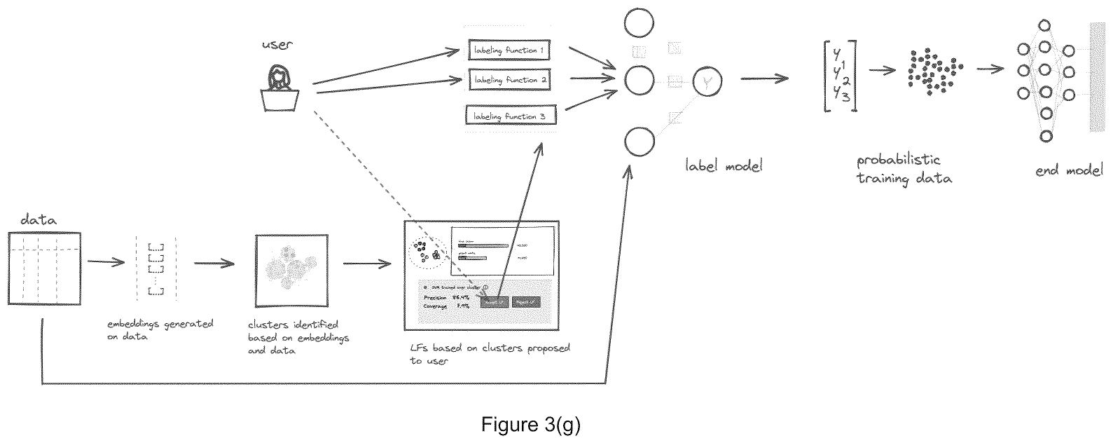

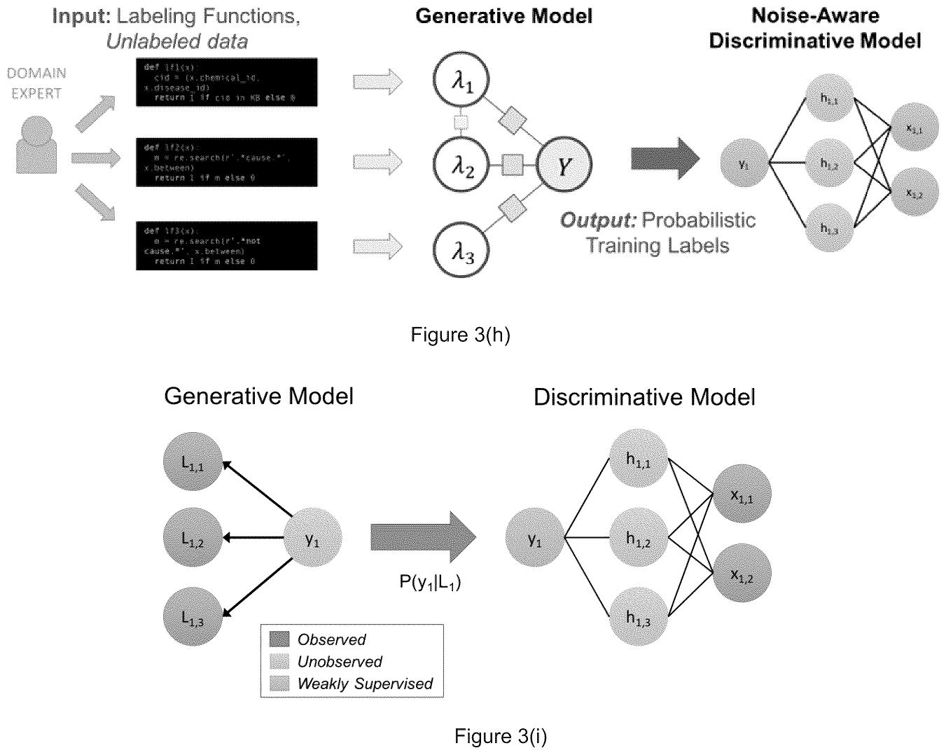

When building an application (such as a trained model) using the disclosed and/or described process of automatically generating labels for training data, a user can select a button (or other user interface element) to create a cluster view using embedding techniques applied to a dataset. If a user already has high-value embeddings, those can be introduced into the processing flow. From there, the process may use “smart” clustering algorithms' to take the guesswork out of the clustering stage. For example, in one embodiment, meaningful groups of data may be displayed using an interactive data map (such as illustrated by FIGS. 3(a) and 3(b)). ¹ These “smart” algorithms are disclosed herein and summarized below:

In addition to a data map, a user may be provided data-driven cards of information for each cluster (such as illustrated by FIG. 3(c)). These help a user to explore the suggested clusters at varying levels of detail to uncover “hidden” (unseen) structure in the data and evaluate whether that structure is meaningful based on the user's knowledge of the data and the purpose of training a model. This provides a user with a curated, meaningful visualization of a large dataset more reliably and efficiently than conventional approaches.

Even more than with image data, understanding a set of text documents is a difficult problem; for example, in contrast to images, there is no “thumbnail” view that is easy to scan and evaluate. The disclosed and/or described processing flow addresses this in two ways.

First, the disclosed approach uses text mining strategies (such as counting n-gram frequencies for n=1 to n=3) to identify salient n-grams that distinguish each cluster of data from the others. Second, a user can review relevant snippets of individual documents in the same UI pane. This keeps a user's data front-and-center throughout the AI development workflow.

Beyond the initially generated clusters, a user can explore the data more granularly using a search functionality to filter on data points that match certain queries. For example, a user can inspect the embeddings for all documents that contain a certain keyword or match a given regular expression. As the user inspects and evaluates the data to develop a better understanding, the clusters are automatically recomputed to show the user the new distribution of the filtered documents across the clusters.

Re-clustering re-uses the existing clustering algorithms but operates over the filtered set of data. Because clustering is dependent on the similarity between documents (as an example), if one re-runs the same algorithm on a subset of data, then the clusters assigned to data points may be different than the originally assigned clusters.

The algorithms attempt to cluster datapoints in the dataset using techniques that assign datapoints to the same group if they share similarities. Examples of such assignment algorithms include DBSCAN or distance-based hierarchical clustering. The degree of similarity can be measured by the similarity between two embeddings, or whether two datapoints share the same ground truth labels. Common similarity metrics are Manhattan distance or Euclidean/Cosine distance, although others exist and may be used. For clustering, Euclidean distance is commonly used to determine whether a datapoint is more likely to belong in one cluster over another by measuring the distance between the datapoint and the centroids of the clusters. To measure the similarity between two datapoints, cosine similarity is commonly used.

The preceding steps or stages of the processing flow for a dataset make exploration of the data from the embeddings more transparent and granular. The next stage is to make the results actionable for a user.

### From Insight to Action

While the data exploration capability and understanding of a dataset obtained using the disclosed and/or described processing flow is beneficial, pairing Cluster View with the programmatic labeling technology developed by the assignee provides even greater benefits. For each of the clusters, the programmatic labeling process flow can use a relatively small amount of ground truth data (as an example, hundreds instead of thousands of labeled documents) to auto-generate cluster labeling functions (LFs). A user can review and choose to accept or reject the labeling functions for use as sources of weak supervision to label training data. For example, data is grouped into clusters, and a classifier is trained for each cluster. Each classifier is thus a form or example of a cluster labeling function.

The proposed clusters are parameterized so that new data points added to the dataset can be identified as belonging to that part of the embedding space. In one embodiment, this parametrization process is the SVM/classifier training process described, and the parameters are the parameters that define a classifier. The “clusters” are defined by a classifier deciding whether a new datapoint is in a cluster or not.

As disclosed, in some embodiments, the parameterizations are “intelligently” selected and more complex than simple centroid or distance-based approaches that may suffer from the problem of dimensionality and tend to underperform in the higher dimensional spaces typical of unstructured text. Instead of a rule-based system that determines whether a new point belongs in a cluster, the disclosed and/or described process uses a classifier to determine if a new data point belongs in a particular cluster. This is beneficial, as classifiers can learn subtle patterns that help deal with data that is not obviously separable. This characteristic is helpful because text is often represented in the form of embeddings in a high dimensional space, so two points that are far from each other might belong in the same cluster. Therefore, this type of data might be mis-labeled using a simple rule-based approach.

To inform a user's decision about whether to save an auto-generated cluster labeling function, a user may apply their “expert” judgment and insight into each cluster as well as the estimated precision and coverage of that proposed labeling function (which are provided to the user). The same auto-generated labeling function option is available for filtered views of the proposed clusters, allowing a user to efficiently create targeted, granular labeling functions. The auto-generated labeling functions provide a mechanism to bootstrap a labeling effort, and the insights from cluster exploration may provide motivation for additional labeling functions that are useful for the dataset or for a different dataset.

In some embodiments, the processing flow takes a relatively large, unstructured dataset of complex text documents (or other type of data) and provides a visualization of embedding-based clustering. A user can inspect each cluster to understand the meaning behind it and explore explicit data points. A user can filter the proposed clusters using a search functionality to see how specific slices of data distribute across clusters and uncover nuances of a dataset.

As a user explores and better understands the proposed clusters, they can take informed actions by saving and applying auto-generated labeling functions that are used to programmatically label a dataset. This can be followed by continuing with the core functionality of the overall workflow to label data, generate a trained model, and make any desired adaptations. This includes using feedback from one or more forms of model-based error analysis (such as precision or coverage, as suggested by FIG. 3(d)) to identify error modes and iterate programmatically to improve the labeling and value of the data (as illustrated by FIG. 3(d)). FIG. 3(e) illustrates another user interface display that may be presented to a user to assist them in exploring and evaluating a set of clusters and an associated labeling function.

Clustering embeddings is a powerful way to visualize semantic similarities across a global view of a dataset, especially when that data is complex. For users who want to better understand unstructured text to build high-performing AI models and systems, these visualizations surface insights that might otherwise be difficult to discover. While clustering embeddings may provide directional insights or identify ways to explore data, it is often unclear what the rationale is behind a given cluster, or how to act on that. As a result, embeddings have largely been considered “black box” artifacts; they are interesting, but do not always concretely move AI projects forward.

In contrast, the disclosed and/or described process flow (Cluster View) functions to increase the value of embeddings by providing a specific set of features and benefits, including (as examples):
Providing aggregated data to enable a user to more quickly understand groups of text documents (or other sources), while allowing a user to explore individual documents;
Automatically re-clustering subsets of data, to refine data analysis and evaluation; and
Providing an efficient path from a cluster view to generating labeled training data.
   As a data-centric AI platform, a goal underlying Cluster View is to strengthen data exploration and understanding and make data labeling programmatic rather than manual. The disclosed and/or described approach is also intended to make these workflows as efficient as possible to reduce overhead and increase the pace of delivery of trained models and applications.

Once clusters have been created, a user can explore them at varying levels of detail to understand what's motivating a grouping and whether it is intuitive based on the user's knowledge of the data and task at hand. As mentioned, understanding groups of text documents is a difficult problem. To address this obstacle, embodiments may use text mining strategies to identify salient, discriminative text that distinguishes one cluster of documents from those in other clusters. A user can also review relevant snippets of individual documents directly in a UI pane.

This allows a user to use their own experience, “expert” judgment, and insight into each cluster to decide whether to save a particular auto-generated labeling function (LF). In addition, embodiments provide an estimated precision and coverage for each suggested labeling function. The same LF creation capability is available for filtered views of a cluster, allowing a user to create more targeted, granular labeling functions.

Embodiments permit a user to inspect each of the proposed clusters to understand the meaning behind it and explore explicit data points. A user can filter the clusters using a search functionality to better understand how specific slices of data are distributed across clusters and assist in identifying more subtle aspects of the dataset and the relationships between data and clusters. As a user develops a greater understanding of the clusters and their contents, the user can take informed action to save and apply auto-generated labeling functions that are used to programmatically label a dataset. Next, as mentioned, the core workflow processes of label, model, and adaptation are executed. This allows using feedback from model-based error analysis to identify error modes and iterate programmatically.

FIGS. 3 (a) through 3(e) are diagrams illustrating a set of displays or user interfaces that may be used in some embodiments. A further description of the illustrated user interface elements and functionality is contained herein.

FIGS. 3(f) and 3(g) are diagrams illustrating the use of the disclosed clustering approach as part of the programmatic labeling of datapoints and use of the labeled datapoints as training data for a machine learning model, in accordance with some embodiments.

FIG. 3(f) shows how the disclosed Cluster View approach fits into a high-level workflow for data-centric AI. In one embodiment, the workflow is as follows: data is uploaded to the platform; embeddings are computed over that data; Cluster View is used to explore the clustered data and evaluate possible labeling functions (LFs); a subset of these possible LFs are created; the LFs are used to train a model; that model is analyzed for errors; and the errors are corrected by using Cluster View to explore for more data to label. FIG. 3(g) provides an alternative illustration of the same high-level workflow, showing explicit steps for how the created LFs are turned into probabilistic training data to train a model.

FIGS. 3(h) and 3(i) are diagrams illustrating the use of a generative model in combination with a discriminative model as part of a process to generate labels for use in training a machine learning model, in accordance with some embodiments.

FIG. 3(h) shows how a domain expert can produce probabilistic training labels for training a model. In one example embodiment, a domain expert writes labeling functions that execute over unlabeled training data, and these labeling functions are used to train a generative model (the label model) that outputs probabilistic training labels. These labels are then used to train a discriminative model. FIG. 3(i) shows a more detailed view of the same process, with a legend indicating how the different terms in the figure relate to observed, unobserved, and weakly supervised data.

Since labeling functions are snippets of code, they can be used to encode arbitrary signals, patterns, heuristics, external data resources, noisy labels from crowd workers, or weak classifiers, as non-limiting examples. And, as code, embodiments can benefit from other of the associated benefits such as modularity, reusability, or debuggability.

One potential problem is that the labeling functions may produce noisy outputs which overlap and conflict, producing less-than-ideal training labels. In one embodiment, the process operates to de-noise these labels using a data programming approach, comprising the following steps:
Apply the labeling functions to unlabeled data;
Use a generative model to learn the accuracies of the labeling functions without any labeled data, and weight their outputs accordingly. This process may even learn the structure of labeling function correlations automatically;
The generative model outputs a set of probabilistic training labels, which can be used to train a flexible discriminative model (such as a deep neural network) that will generalize beyond the signal expressed in the labeling functions.

In some embodiments, the labeling functions may be considered to implicitly describe a generative model. Given data points x, having unknown labels y that a user wants to predict, in a discriminative approach one would model P(y|x) directly, while in a generative approach one models this as P(x,y)=P(x|y)P(y). In the disclosed and/or described embodiments, one is modeling a process of training set labeling, P(L,y), where L are the labels generated by the labeling functions for objects x, and y are the corresponding (unknown) true labels. By learning a generative model, and directly estimating P(L|y), the process is essentially learning the relative accuracies of the labeling functions based on how they overlap and conflict.

Embodiments then use this estimated generative model over the labeling functions to train a noise-aware version of an end discriminative model. To do so, the generative model infers probabilities over the unknown labels of the training data, and then the process minimizes the expected loss of the discriminative model with respect to these probabilities.

Estimating the parameters of a generative model can be complicated, especially when there are statistical dependencies between the labeling functions used (either user-expressed or inferred). Work performed by the inventors suggests that given sufficient labeling functions, one can obtain similar asymptotic scaling as with supervised methods in some use cases. The inventors also investigated how the process can learn correlations among the labeling functions without using labeled data and how that can improve performance.

The weak supervision interaction model (parts of which are disclosed and/or described herein) may be extended to other modalities, such as richly formatted data and images, supervising tasks with natural language, and generating labeling functions automatically. Extending the core data programming model is expected to make it easier to specify labeling functions with higher-level interfaces such as natural language, as well as assist in combining with other types of weak supervision, such as data augmentation.

The increasing prevalence of multi-task learning (MTL) scenarios may suggest a concern regarding the impact when noisy, possibly correlated label sources are used to label multiple, related tasks. This potential problem can be addressed by modeling the supervision for these tasks jointly. A multitask-aware version of the disclosed and/or described approach can be used to support multi-task weak supervision sources that provide noisy labels for one or more related tasks.

As a non-limiting example, consider the setting of label sources with different granularities. For example, suppose one desires to train a fine-grained named entity recognition (NER) model to tag mentions of specific types of people and locations, and some of the noisy labels are relatively fine-grained, e.g., Labeling “Lawyer” vs. “Doctor” or “Bank” vs. “Hospital”, and some are relatively coarse-grained, e.g., labeling “Person” vs. “Location”. By representing these sources as labeling different hierarchically related tasks, one can jointly model their accuracies, and reweight and combine the respective multi-task labels to create cleaner, more intelligently aggregated multi-task training data that improves the end MTL model performance.

Consider the example of a massively multi-task regime, where tens to hundreds of weakly-supervised (and thus highly dynamic) tasks interact in complex and varied ways. While most MTL work to date has considered a handful of tasks defined by static hand-labeled training sets, enterprises are advancing to a state where organizations (whether large companies, academic labs, or online communities) maintain tens to hundreds of weakly-supervised, rapidly changing, and interdependent modeling tasks. Moreover, because these tasks are weakly supervised, developers can add, remove, or change tasks (i.e., training sets) in hours or days, rather than months or years, potentially necessitating the retraining of an entire model.

Embodiments of the approach disclosed and/or described herein can be adapted to assist in the automatic labeling of data and hence the more efficient training of such models. For example, when an enterprise adds a new modeling task, the approach can automatically re-cluster the data and propose new clusters based upon the inclusion of the new modeling task.

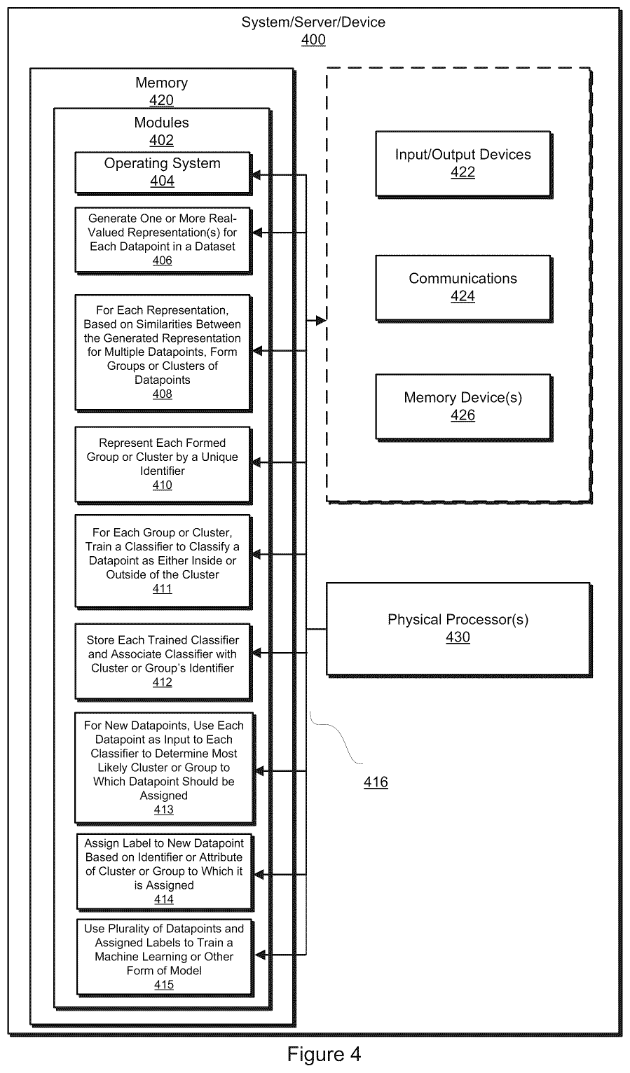

FIG. 4 is a diagram illustrating elements, components, or processes that may be present in or executed by one or more of a computing device, server, platform, or system 400 configured to implement a method, process, function, or operation in accordance with some embodiments. In some embodiments, the disclosed and/or described system and methods may be implemented in the form of an apparatus or apparatuses (such as a server that is part of a system or platform, or a client device) that includes a processing element and a set of computer-executable instructions. The executable instructions may be part of a software application (or applications) and arranged into a software architecture.

In general, an embodiment may be implemented using a set of software instructions that are designed to be executed by a suitably programmed processing element (such as a GPU, CPU, TPU, QPU, microprocessor, processor, controller, state machine, or other computing device, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed and/or described systems, apparatuses, and methods.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

A module may contain instructions that are executed by a processor contained in more than one of a server, client device, network element, system, platform, or other component. Thus, in some embodiments, a plurality of electronic processors, with each being part of a separate device, server, or system may be responsible for executing all or a portion of the software instructions contained in an illustrated module. Thus, although FIG. 4 illustrates a set of modules which taken together perform multiple functions or operations, these functions or operations may be performed by different devices or system elements, with certain of the modules (or instructions contained in those modules) being associated with and executed by those devices or system elements.

As shown in FIG. 4, system 400 may represent one or more of a server, client device, platform, or other form of computing or data processing device. Modules 402 each contain a set of computer-executable instructions, where when the set of instructions is executed by a suitable electronic processor (such as that indicated in the figure by “Physical Processor(s) 430”), system (or server, or device) 400 operates to perform a specific process, operation, function, or method.

Modules 402 may contain one or more sets of instructions for performing a method or function described with reference to the Figures, and the disclosure and/or description of the functions and operations provided in the specification. These modules may include those illustrated but may also include a greater number or fewer number than those illustrated. Further, the modules and the set of computer-executable instructions that are contained in the modules may be executed (in whole or in part) by the same processor or by more than a single processor. If executed by more than a single processor, the other processors may be contained in different devices, for example a processor in a client device and a processor in a server.

Modules 402 are stored in a memory 420, which typically includes an Operating System module 404 that contains instructions used (among other functions) to access and control the execution of the instructions contained in other modules. The modules 402 in memory 420 are accessed for purposes of transferring data and executing instructions by use of a “bus” or communications line 416, which also serves to permit processor(s) 430 to communicate with the modules for purposes of accessing and executing instructions. Bus or communications line 416 also permits processor(s) 430 to interact with other elements of system 400, such as input or output devices 422, communications elements 424 for exchanging data and information with devices external to system 400, and additional memory devices 426.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor, processors, or co-processors cause the processor(s) or co-processors (or a device, devices, server, or servers in which they are contained) to perform the specific function, method, process, or operation. As mentioned, an apparatus in which a processor or co-processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed and/or described system and methods, such as for:
Generating One or More Real-Valued Representations for Each Datapoint in a Dataset (as suggested by module 406);
As disclosed, this may involve a technique chosen based on the type of data and/or the task for which a model is to be trained;
For each of the generated representations, perform the following steps or stages;
For Each Representation, Based on Similarities Between the Generated Representation for Multiple Datapoints, Forming Groups or Clusters of Datapoints (module 408);
Similarity may be based on a chosen metric and a selected threshold value for inclusion or exclusion from a specific cluster;
Representing Each Formed Group or Cluster by a Unique Identifier (module 410);
The identifier may be selected by reference to a common attribute of the grouped datapoints, as an example;
   In some embodiments, the unique identifier may be generated by a process that determines one or more common features of the grouped datapoints that distinguish them from the members of the other groups or clusters, such as the presence or absence of a characteristic, the presence or absence of a word or phrase, the presence or absence of an object, or a state of a system or process represented by the datapoint;
For Each Group or Cluster, Training a Classifier to Classify a Datapoint as Either Inside or Outside of the Cluster (module 411);
This will result in a set of classifiers, with one corresponding to each of the groups or clusters;
Each such classifier may be evaluated using a set of datapoints to determine the classifier's accuracy and the utility of the assigned identifier (which may later serve as a label for datapoints assigned to the cluster);
Storing Each Trained Classifier and Associating the Classifier with the Cluster or Group's Identifier (module 412);
For New Datapoints, Using Each Datapoint as an Input to Each Classifier to Determine the Most Likely Cluster or Group to Which Datapoint Should be Assigned (module 413);
Assigning a Label to New Datapoint Based on Identifier or Attribute of Cluster or Group to Which it is Assigned (module 414); and
Using a Plurality of Datapoints and Assigned Labels to Train a Machine Learning or Other Form of Model (module 415).

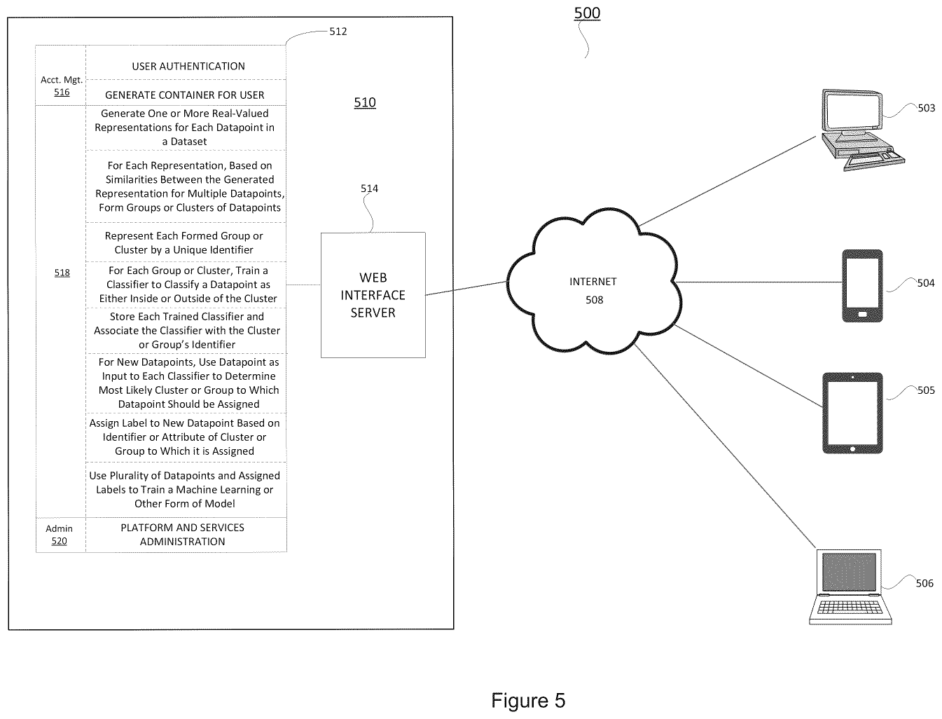

In some embodiments, the functionality and services provided by the system, apparatuses, and methods disclosed herein may be made available to multiple users by accessing an account maintained by a server or service platform. Such a server or service platform may be termed a form of Software-as-a-Service (SaaS). FIGS. 5, 6, and 7 are diagrams illustrating an architecture for a multi-tenant or SaaS platform that may be used in implementing an embodiment of the systems, apparatuses, and methods disclosed and/or described herein.

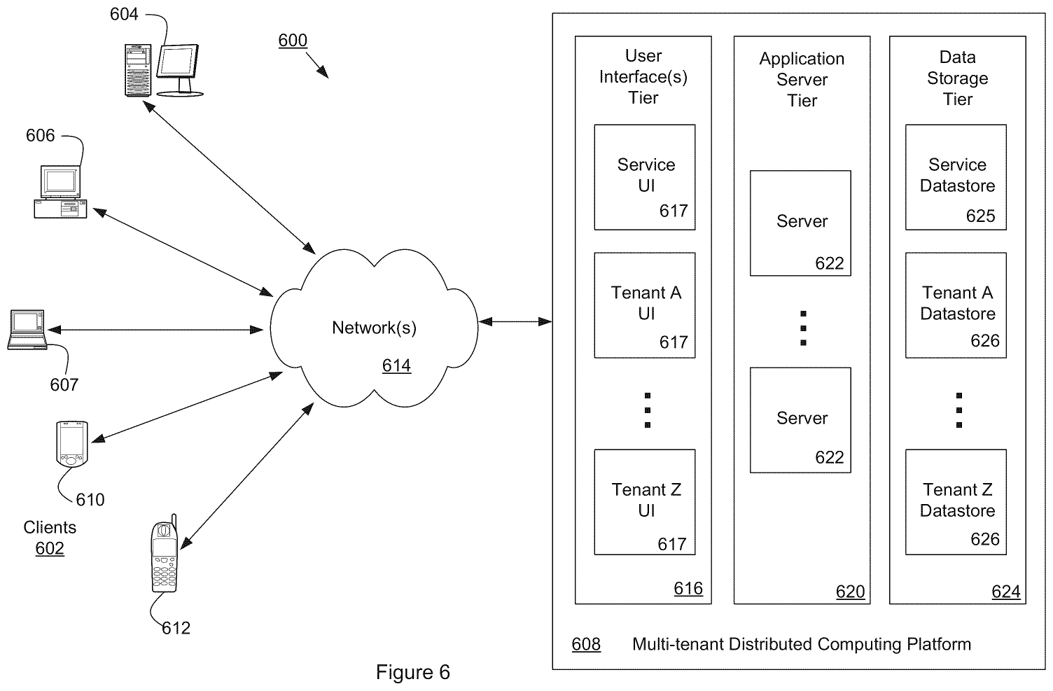

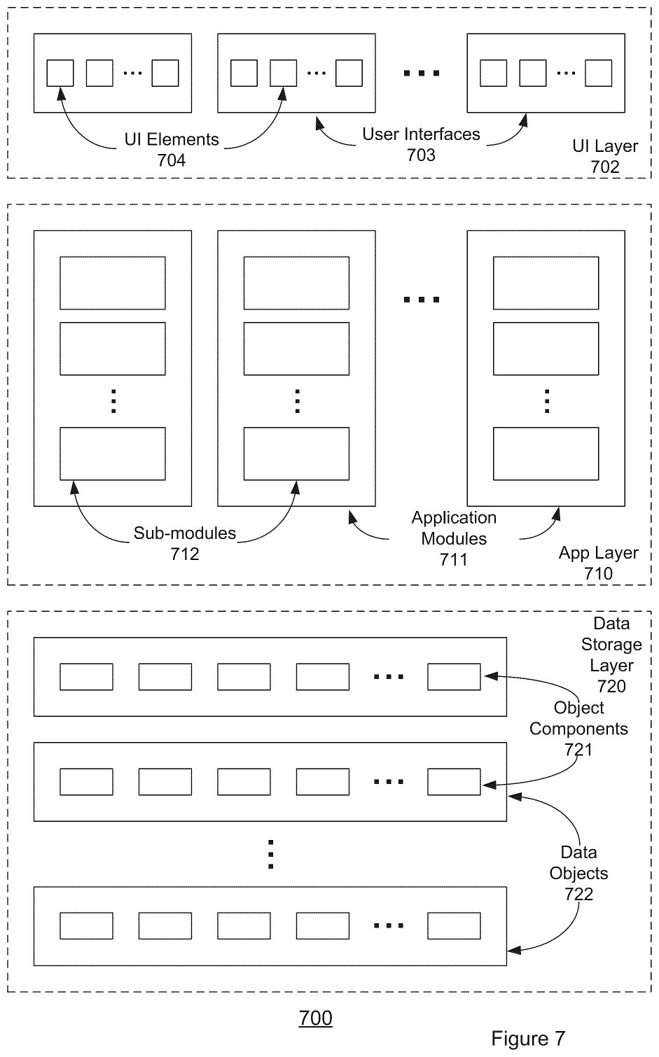

FIG. 5 is a diagram illustrating a SaaS system in which an embodiment may be implemented. FIG. 6 is a diagram illustrating elements or components of an example operating environment in which an embodiment may be implemented. FIG. 7 is a diagram illustrating additional details of the elements or components of the multi-tenant distributed computing service platform of FIG. 6, in which an embodiment may be implemented.

In some embodiments, the system or services disclosed and/or described herein may be implemented as microservices, processes, workflows or functions performed in response to the submission of a set of input data. The microservices, processes, workflows or functions may be performed by a server, data processing element, platform, or system. In some embodiments, the data analysis and other services may be provided by a service platform located “in the cloud”. In such embodiments, the platform may be accessible through APIs and SDKs.

The functions, processes, and capabilities disclosed and/or described herein with reference to one or more of the Figures may be provided as microservices within the platform. The interfaces to the microservices may be defined by REST and GraphQL endpoints. An administrative console may allow users or an administrator to securely access the underlying request and response data, manage accounts and access, and in some cases, to modify the processing workflow or configuration.

Note that although FIGS. 5, 6, and 7 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide one or more of the processes, functions, and operations disclosed and/or described herein. Although in some embodiments, a platform or system of the type illustrated in the Figures may be operated by a service provider to provide a specific set of services or applications, in other embodiments, the platform may be operated by a provider and a different entity may provide the applications or services for users through the platform.

FIG. 5 is a diagram illustrating a system 500 in which an embodiment may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, or organizations, as examples. A user may access the services using a suitable client device or application. In general, a client device having access to the Internet may be used to provide data to the platform for processing and evaluation. A user interfaces with the service platform across the Internet 508 or another suitable communications network or combination of networks. Examples of suitable client devices include desktop computers 503, smartphones 504, tablet computers 505, or laptop computers 506.

System 510, which may be hosted by a third party, may include a set of data processing and other services to assist in automatically generating labels for training data for use in training a model or system 512, and a web interface server 514, coupled as shown in FIG. 5. Either or both the data processing and other services 512 and the web interface server 514 may be implemented on one or more different hardware systems and components, even though represented as singular units in FIG. 5.

Services 512 may include one or more functions or operations for the processing of a set of data, generating representations of the datapoints, forming clusters from the generated representations, and generating labeling functions/labels for data to be used to train a model.

As examples, in some embodiments, the set of functions, operations or services made available through the platform or system 510 may include:
Account Management services 516, such as:
   a process or service to authenticate a user wishing to utilize services available through access to the SaaS platform;
   processor service to generate a container or instantiation of the data processing and automated label generation services for that user;
A set of processes or services 518 to
   Generate One or More Real-Valued Representations for Each Datapoint in a Dataset;
      As disclosed, this may involve a technique chosen based on the type of data and/or the task for which a model is to be trained;
      For each of the generated representations, perform the following steps or stages;
   For Each Representation, Based on Similarities Between the Generated Representation for Multiple Datapoints, Form Groups or Clusters of Datapoints;
      Similarity may be based on a chosen metric and a selected threshold value for inclusion or exclusion from a specific cluster;
   Represent Each Formed Group or Cluster by a Unique Identifier;
      The identifier may be selected by reference to a common attribute of the grouped datapoints, as an example;
         In some embodiments, the unique identifier may be generated by a process that determines one or more common features of the grouped datapoints that distinguish them from the members of the other groups or clusters, such as the presence or absence of a characteristic, the presence or absence of a word or phrase, the presence or absence of an object, or a state of a system or process represented by the datapoint;
   For Each Group or Cluster, Train a Classifier to Classify a Datapoint as Either Inside or Outside of the Cluster;
      This will result in a set of classifiers, with one corresponding to each of the groups or clusters;
      Each such classifier may be evaluated using a set of datapoints to determine the classifier's accuracy and the utility of the assigned identifier (which may later serve as a label for datapoints assigned to the cluster);
   Store Each Trained Classifier and Associate the Classifier with the Cluster or Group's Identifier;
   For New Datapoints, Use Each Datapoint as an Input to Each Classifier to Determine the Most Likely Cluster or Group to Which Datapoint Should be Assigned;
   Assign a Label to New Datapoint Based on Identifier or Attribute of Cluster or Group to Which it is Assigned; and
   Use Plurality of Datapoints and Assigned Labels to Train a Machine Learning or Other Form of Model; and
Administrative services 520, such as:
   a process or services to provide platform and services administration—for example, to enable the provider of the services and/or the platform to administer and configure the processes and services provided to users.

The platform or system illustrated in FIG. 5 may be hosted on a distributed computing system made up of at least one, but typically multiple, “servers.” A server is a physical computer dedicated to providing data storage and an execution environment for one or more software applications or services to address the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server provides, it could be referred to as a database server, data storage server, file server, mail server, print server, or web server. A web server is most often a combination of hardware and the software that helps deliver content, commonly by hosting a website, to client web browsers that access the web server via the Internet.

FIG. 6 is a diagram illustrating elements or components of an example operating environment 600 in which an embodiment of the disclosure may be implemented. As shown, a variety of clients 602 incorporating and/or incorporated into a variety of computing devices may communicate with a multi-tenant service platform 608 through one or more networks 614. For example, a client may incorporate and/or be incorporated into a client application (e.g., computer-executable software instructions) implemented at least in part by one or more of the computing devices.

Examples of suitable computing devices include personal computers, server computers 604, desktop computers 606, laptop computers 607, notebook computers, tablet computers or personal digital assistants (PDAs) 610, smart phones 612, cell phones, and consumer electronic devices incorporating one or more computing device components (e.g., one or more electronic processors, microprocessors, central processing units (CPU), TPUs, GPUs, QPUs, state machines, or controllers). Examples of suitable networks 614 include networks utilizing wired and/or wireless communication technologies and networks operating in accordance with a suitable networking and/or communication protocol (e.g., the Internet).

The distributed computing service/platform (which may be referred to as a multi-tenant data processing platform) 608 may include multiple processing tiers, including a user interface tier 616, an application server tier 620, and a data storage tier 624. The user interface tier 616 may maintain multiple user interfaces 617, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure), and which may be accessed via one or more APIs.

A default user interface may include user interface components enabling a tenant to administer the tenant's access to and use of the functions and capabilities provided by the service platform. This may include accessing tenant data, launching an instantiation of a specific application, or causing the execution of specific data processing operations, as examples.

Each application server or processing element 622 shown in the figure may be implemented with a set of computers and/or components including servers and processors, and may perform various functions, methods, processes, or operations as determined by the execution of a software application or set of instructions. The data storage tier 624 may include one or more datastores, which may include a Service Datastore 625 and one or more Tenant Datastores 626. Datastores may be implemented with a suitable data storage technology, including structured query language (SQL) based relational database management systems (RDBMS).

Service Platform 608 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information.

Such functions or applications are typically implemented by the execution of one or more modules of software code (in the form of computer-executable instructions) by one or more servers 622 that are part of the platform's Application Server Tier 620. As noted with regards to FIG. 5, the platform system shown in FIG. 6 may be hosted on a distributed computing system made up of at least one, but typically multiple, “servers.”

Rather than build and maintain such a platform or system themselves, a business may utilize systems provided by a third party. A third party may implement a system/platform as disclosed herein in the context of a multi-tenant platform, where individual instantiations of a business' data processing workflow (such as the clustering and programmatic labeling services disclosed herein) are provided to users, with each business representing a tenant of the platform. One advantage to such multi-tenant platforms is the ability for each tenant to customize their instantiation of the data processing workflow to that tenant's specific needs or operational methods. Each tenant may be a business or entity that uses the multi-tenant platform to provide services and functionality to multiple users.

FIG. 7 is a diagram illustrating additional details of the elements or components of the multi-tenant distributed computing service platform of FIG. 6, with which an embodiment may be implemented. In general, an embodiment may be implemented using a set of software instructions that are designed to be executed by a suitably programmed processing element (such as a CPU, GPU, TPU, QPU, state machine, microprocessor, processor, controller, or computing device). In a complex system such instructions are typically arranged into “modules” with each module performing a specific task, process, function, or operation. The entire set of modules may be controlled or coordinated in their operation by an operating system (OS) or other form of organizational platform.

As noted, FIG. 7 is a diagram illustrating additional details of the elements or components 700 of a multi-tenant distributed computing service platform, with which an embodiment may be implemented. The example architecture includes a user interface (UI) layer or tier 702 having one or more user interfaces 703. Examples of such user interfaces include graphical user interfaces and application programming interfaces (APIs). Each user interface may include one or more interface elements 704. Users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 710 may include one or more application modules 711, each having one or more sub-modules 712. Each application module 711 or sub-module 712 may correspond to a function, method, process, or operation that is implemented by the module or sub-module (e.g., a function or process related to providing data processing and services to a user of the platform). Such function, method, process, or operation may include those used to implement one or more aspects of the disclosed and/or described system and methods, such as for one or more of the processes or functions described with reference to the Figures:
Generate One or More Real-Valued Representations for Each Datapoint in a Dataset;
   As disclosed, this may involve a technique chosen based on the type of data and/or the task for which a model is to be trained;
   For each of the generated representations, perform the following steps or stages;
For Each Representation, Based on Similarities Between the Generated Representation for Multiple Datapoints, Forming Groups or Clusters of Datapoints;
   Similarity may be based on a chosen metric and a selected threshold value for inclusion or exclusion from a specific cluster;
Represent Each Formed Group or Cluster by Unique Identifier;
   The identifier may be selected by reference to a common attribute of the grouped datapoints, as an example;
   In some embodiments, the unique identifier may be generated by a process that determines one or more common features of the grouped datapoints that distinguish them from the members of the other groups or clusters, such as the presence or absence of a characteristic, the presence or absence of a word or phrase, the presence or absence of an object, or a state of a system or process represented by the datapoint;
For Each Group or Cluster, Train a Classifier to Classify a Datapoint as Either Inside or Outside of the Cluster;
   This will result in a set of classifiers, with one corresponding to each of the groups or clusters;
   Each such classifier may be evaluated using a set of datapoints to determine the classifier's accuracy and the utility of the assigned identifier (which may later serve as a label for datapoints assigned to the cluster);
Store Each Trained Classifier and Associate the Classifier with the Cluster or Group's Identifier;
For New Datapoints, Use Each Datapoint as an Input to Each Classifier to Determine the Most Likely Cluster or Group to Which Datapoint Should be Assigned;
Assign a Label to New Datapoint Based on Identifier or Attribute of Cluster or Group to Which it is Assigned; and
Use Plurality of Datapoints and Assigned Labels to Train a Machine Learning or Other Form of Model.

The application modules and/or sub-modules may include any suitable computer-executable code or set of instructions (e.g., as would be executed by a suitably programmed processor, microprocessor, GPU, TPU, QPU, state machine, or CPU, as non-limiting examples), such as computer-executable code corresponding to a programming language. For example, programming language source code may be compiled into computer-executable code. Alternatively, or in addition, the programming language may be an interpreted programming language such as a scripting language. Each application server (e.g., as represented by element 622 of FIG. 6) may include each application module. Alternatively, different application servers may include different sets of application modules. Such sets may be disjoint or overlapping.

The data storage layer 720 may include one or more data objects 722 each having one or more data object components 721, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each datastore in the data storage layer may include each data object. Alternatively, different datastores may include different sets of data objects. Such sets may be disjoint or overlapping.

Note that the example computing environments depicted in FIGS. 5, 6, and 7 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:

1. A method of training a machine learning model, comprising:
generating a real-valued representation for each datapoint in a dataset;
based on a similarity between the generated representations, forming one or more groups or clusters of datapoints;
representing each formed group or cluster by a unique identifier;
for each group or cluster, training a classifier to classify a datapoint as either inside or outside the group or cluster;
storing each trained classifier and associating the stored trained classifier with the cluster or group's unique identifier;
for each new datapoint, using the new datapoint as input to each trained classifier and determining a most likely cluster or group to which the new datapoint is assigned;
assigning a label to the new datapoint based on the identifier of the cluster or group to which the new datapoint is assigned; and
using a plurality of new datapoints and the new datapoints' assigned labels to train a machine learning model.

2. The method of clause 1, wherein the real-valued representation for each datapoint in a dataset is generated by an embedding process.

3. The method of clause 2, wherein the embedding process is a text embedding process.

4. The method of clause 1, wherein the unique identifier is based on one or more attributes of a datapoint or datapoints in the cluster or group.

5. The method of clause 1, wherein determining a most likely cluster or group to which the new datapoint should be assigned further comprises determining the cluster or group associated with the trained classifier having the highest level of certainty in its output.

6. The method of clause 1, wherein the similarity between the generated representations is determined based on a metric.

7. The method of clause 6, wherein the metric is one of Manhattan distance, Euclidean distance, or Cosine distance.

8. The method of clause 1, wherein instead of generating a real-valued representation for each datapoint in a dataset, a plurality of real-valued representations for each datapoint in a dataset are generated, and for each of the plurality of representations, the method proceeds as described.

9. A system, comprising:
one or more electronic processors configured to execute a set of computer-executable instructions; and
one or more non-transitory electronic data storage media containing the set of computer-executable instructions, wherein when executed, the instructions cause the one or more electronic processors to
   generate a real-valued representation for each datapoint in a dataset;
   based on a similarity between the generated representations, form one or more groups or clusters of datapoints;
   represent each formed group or cluster by a unique identifier;
   for each group or cluster, train a classifier to classify a datapoint as either inside or outside the group or cluster;
   store each trained classifier and associate the stored trained classifier with the cluster or group's unique identifier;
   for each new datapoint, use the new datapoint as input to each trained classifier and determine a most likely cluster or group to which the new datapoint is assigned;
   assign a label to the new datapoint based on the identifier of the cluster or group to which the new datapoint is assigned; and
   use a plurality of new datapoints and the new datapoints' assigned labels to train a machine learning model.

10. The system of clause 9, wherein the real-valued representation for each datapoint in a dataset is generated by an embedding process.

11. The system of clause 9, wherein the unique identifier is based on one or more attributes of a datapoint or datapoints in the cluster or group.

12. The system of clause 9, wherein determining a most likely cluster or group to which the new datapoint should be assigned further comprises determining the cluster or group associated with the trained classifier having the highest level of certainty in its output.

13. The system of clause 9, wherein the similarity between the generated representations is determined based on a metric, and further, wherein the metric is one of Manhattan distance, Euclidean distance, or Cosine distance.

14. The system of clause 9, wherein instead of generating a real-valued representation for each datapoint in a dataset, a plurality of real-valued representations for each datapoint in a dataset are generated, and for each of the plurality of representations, the method proceeds as described.

15. One or more non-transitory computer-readable media comprising a set of computer-executable instructions that when executed by one or more programmed electronic processors, cause the processors to:
generate a real-valued representation for each datapoint in a dataset;
based on a similarity between the generated representations, form one or more groups or clusters of datapoints;
represent each formed group or cluster by a unique identifier;
for each group or cluster, train a classifier to classify a datapoint as either inside or outside the group or cluster;
store each trained classifier and associate the stored trained classifier with the cluster or group's unique identifier;
for each new datapoint, use the new datapoint as input to each trained classifier and determine a most likely cluster or group to which the new datapoint is assigned; assign a label to the new datapoint based on the identifier of the cluster or group to which the new datapoint is assigned; and
use a plurality of new datapoints and the new datapoints' assigned labels to train a machine learning model.

16. The one or more non-transitory computer-readable media of clause 15, wherein the real-valued representation for each datapoint in a dataset is generated by an embedding process.

17. The one or more non-transitory computer-readable media of clause 15, wherein the unique identifier is based on one or more attributes of a datapoint or datapoints in the cluster or group.

18. The one or more non-transitory computer-readable media of clause 15, wherein determining a most likely cluster or group to which the new datapoint should be assigned further comprises determining the cluster or group associated with the trained classifier having the highest level of certainty in its output.

19. The one or more non-transitory computer-readable media of clause 15, wherein the similarity between the generated representations is determined based on a metric, and further, wherein the metric is one of Manhattan distance, Euclidean distance, or Cosine distance.

20. The one or more non-transitory computer-readable media of clause 15, wherein instead of generating a real-valued representation for each datapoint in a dataset, a plurality of real-valued representations for each datapoint in a dataset are generated, and for each of the plurality of representations, the method proceeds as described.

The disclosed and/or described system and methods can be implemented in the form of control logic using computer software in a modular or integrated manner. Based on the disclosure and teachings provided herein, a person of ordinary skill in the art may recognize other ways and/or methods to implement an embodiment of the disclosure using hardware and/or a combination of hardware and software.

In some embodiments, certain of the methods, models, processes, operations, or functions disclosed and/or described herein may be embodied in the form of a trained neural network or other form of model derived from a machine learning algorithm. The neural network or model may be implemented by the execution of a set of computer-executable instructions and/or represented as a data structure. The instructions may be stored in (or on) a non-transitory computer-readable medium and executed by a programmed processor or processing element. A neural network or deep learning model may be characterized in the form of a data structure in which are stored data representing a set of layers, with each layer containing a set of nodes, and with connections (and associated weights) between nodes in different layers. The neural network or model operates on an input to provide a decision, prediction, inference, or value as an output.

The set of instructions may be conveyed to a user through a transfer of instructions or an application that executes a set of instructions over a network (e.g., the Internet). The set of instructions or an application may be utilized by an end-user through access to a SaaS platform, self-hosted software, on-premise software, or a service provided through a remote platform.

In general terms, a neural network may be viewed as a system of interconnected artificial “neurons” or nodes that exchange messages between each other. The connections have numeric weights that are “tuned” during a training process, so that a properly trained network will respond correctly when presented with an image, pattern, or set of data. In this characterization, the network consists of multiple layers of feature-detecting “neurons”, where each layer has neurons that respond to different combinations of inputs from the previous layers.

Training of a network is performed using a “labeled” dataset of inputs in an assortment of representative input patterns (or datasets) that are associated with their intended output response. Training uses methods to iteratively determine the weights for intermediate and final feature neurons. In terms of a computational model, each neuron calculates the dot product of inputs and weights, adds a bias, and applies a non-linear trigger or activation function (for example, using a sigmoid response function).

Machine learning (ML) is used to analyze data and assist in making decisions in multiple industries. To benefit from using machine learning, a machine learning algorithm is applied to a set of training data and labels to generate a “model” which represents what the application of the algorithm has “learned” from the training data. Each element (or example) in the form of one or more parameters, variables, characteristics, or “features” of the set of training data is associated with a label or annotation that defines how the element should be classified by the trained model. A machine learning model can predict or infer an outcome based on the training data and labels and be used as part of a decision process. When trained, the model will operate on a new element of input data to generate the correct (or most likely correct) label or classification as an output.

The software components, methods, elements, operations, processes, or functions disclosed and/or described herein may be implemented as software code to be executed by a processor using a suitable computer language such as Python, Java, JavaScript, C, C++, or Perl using conventional or object-oriented techniques. The software code may be stored as a series of computer-executable instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. A computer-readable medium may reside on or within a single computational apparatus or may be present on or within different computational apparatuses within a system or network.

According to one example implementation, the term processing element or processor, as used herein, may be a central processing unit (CPU), or conceptualized as a CPU (such as a virtual machine). In this implementation, the CPU, or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies.

Such computer-readable storage media allow the processing element or processor to access computer-executable processing steps or stages, application programs and the like, stored on removable and non-removable memory media, to off-load data from a device or to upload data to a device. As mentioned, with regards to the embodiments disclosed and/or described herein, a non-transitory computer-readable medium may include almost any structure, technology, or method apart from a transitory waveform or similar medium.

Example implementations of the disclosure are described herein with reference to block diagrams of systems, and/or flowcharts or flow diagrams of functions, operations, processes, or methods. One or more blocks of the block diagrams, or one or more stages or steps of the flowcharts or flow diagrams, and combinations of blocks in the block diagrams and stages or steps of the flowcharts or flow diagrams may be implemented by computer-executable instructions. In some embodiments, one or more of the blocks, or stages or steps may not need to be performed in the order presented or may not need to be performed at all.

The computer-executable program instructions may be loaded onto a general-purpose computer, a special purpose computer, a processor, or other programmable data processing apparatus to produce a specific example of a machine. In this situation, the instructions that are executed by the computer, processor, or other programmable data processing apparatus implement one or more of the functions, operations, processes, or methods disclosed and/or described herein.

The computer program instructions may also (or instead) be stored in (or on) a computer-readable memory that can direct a computer or other programmable data processing apparatus to function in a specific manner. In this embodiment, the instructions stored in the computer-readable memory represent an article of manufacture including instruction means that implement one or more of the functions, operations, processes, or methods disclosed and/or described herein.

While embodiments of the disclosure have been described in connection with what is presently considered to be the most practical form(s) of implementation, it is understood that embodiments are not limited to the disclosed implementations. The disclosed implementations are intended to cover various modifications and equivalent arrangements included within the scope of the appended claims. Although specific terms are employed herein, they are used in a generic and descriptive sense only and not for purposes of limitation.

This written description includes examples to represent possible implementations of one or more embodiments of the disclosure, and to enable a person skilled in the art to practice those implementations, including making and using devices or systems and performing the incorporated methods. The patentable scope of an embodiment of the disclosure is defined in the claims, and may include other examples that occur to those skilled in the art. Such other examples are within the scope of the claims if they have structural and/or functional elements that do not differ from the literal language of the claims, or if they include structural and/or functional elements with insubstantial differences from the literal language of the claims.

All references, including publications, patent applications, and patents cited herein are hereby incorporated by reference to the same extent as if each reference were individually and specifically indicated to be incorporated by reference and/or were set forth in its entirety herein.

The use of the terms “a” and “an” and “the” and similar references in the specification and in the claims are to be construed to cover both the singular and the plural, unless otherwise indicated or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated, and each separate value is incorporated into the specification as if it were individually recited. All methods disclosed and/or described herein can be performed in any suitable order unless otherwise indicated or clearly contradicted by context. The use of all examples or exemplary language (e.g., “such as”) herein is intended to better illuminate embodiments of the disclosure and do not pose a limitation to the scope of the claims. No language in the specification should be construed as indicating any non-claimed element as essential to each embodiment of the disclosure.

As used herein (i.e., in the claims, figures, and specification), the term “or” is used inclusively to refer to items in the alternative and in combination.

Different arrangements of the components, elements, steps, or stages illustrated in the drawings and/or described herein, as well as those not shown or described are possible. Similarly, some features and sub-combinations are useful and may be employed without reference to other features and sub-combinations. Embodiments of the disclosure have been described for illustrative and not for restrictive purposes, and alternative embodiments may be apparent to a reader of the disclosure. Accordingly, embodiments and modifications may be made without departing from the scope of the claims below.

That which is claimed is:

1. A method of training a machine learning model, comprising:
generating a real-valued representation for each datapoint in a dataset;
based on a similarity between the generated representations, forming one or more groups or clusters of datapoints;
representing each formed group or cluster by a unique identifier;
for each group or cluster, training a classifier to classify a datapoint as either inside or outside the group or cluster;
storing each trained classifier and associating the stored trained classifier with the cluster or group's unique identifier;
for each new datapoint, using the new datapoint as input to each trained classifier and determining a most likely cluster or group to which the new datapoint is assigned;
assigning a label to the new datapoint based on the identifier of the cluster or group to which the new datapoint is assigned; and
using a plurality of new datapoints and the new datapoints' assigned labels to train a machine learning model.

2. The method of claim 1, wherein the real-valued representation for each datapoint in a dataset is generated by an embedding process.

3. The method of claim 2, wherein the embedding process is a text embedding process.

4. The method of claim 1, wherein the unique identifier is based on one or more attributes of a datapoint or datapoints in the cluster or group.

5. The method of claim 1, wherein determining a most likely cluster or group to which the new datapoint should be assigned further comprises determining the cluster or group associated with the trained classifier having the highest level of certainty in its output.

6. The method of claim 1, wherein the similarity between the generated representations is determined based on a metric.

7. The method of claim 6, wherein the metric is one of Manhattan distance, Euclidean distance, or Cosine distance.

8. The method of claim 1, wherein instead of generating a real-valued representation for each datapoint in a dataset, a plurality of real-valued representations for each datapoint in a dataset are generated, and for each of the plurality of representations, the method proceeds as described.

9. A system, comprising:
one or more electronic processors configured to execute a set of computer-executable instructions; and
one or more non-transitory electronic data storage media containing the set of computer-executable instructions, wherein when executed, the instructions cause the one or more electronic processors to
generate a real-valued representation for each datapoint in a dataset;
based on a similarity between the generated representations, form one or more groups or clusters of datapoints;
represent each formed group or cluster by a unique identifier;
for each group or cluster, train a classifier to classify a datapoint as either inside or outside the group or cluster;
store each trained classifier and associate the stored trained classifier with the cluster or group's unique identifier;
for each new datapoint, use the new datapoint as input to each trained classifier and determine a most likely cluster or group to which the new datapoint is assigned;
assign a label to the new datapoint based on the identifier of the cluster or group to which the new datapoint is assigned; and
use a plurality of new datapoints and the new datapoints' assigned labels to train a machine learning model.

10. The system of claim 9, wherein the real-valued representation for each datapoint in a dataset is generated by an embedding process.

11. The system of claim 9, wherein the unique identifier is based on one or more attributes of a datapoint or datapoints in the cluster or group.

12. The system of claim 9, wherein determining a most likely cluster or group to which the new datapoint should be assigned further comprises determining the cluster or group associated with the trained classifier having the highest level of certainty in its output.

13. The system of claim 9, wherein the similarity between the generated representations is determined based on a metric, and further, wherein the metric is one of Manhattan distance, Euclidean distance, or Cosine distance.

14. The system of claim 9, wherein instead of generating a real-valued representation for each datapoint in a dataset, a plurality of real-valued representations for each datapoint in a dataset are generated, and for each of the plurality of representations, the method proceeds as described.

15. One or more non-transitory computer-readable media comprising a set of computer-executable instructions that when executed by one or more programmed electronic processors, cause the processors to:
generate a real-valued representation for each datapoint in a dataset;
based on a similarity between the generated representations, form one or more groups or clusters of datapoints;
represent each formed group or cluster by a unique identifier;
for each group or cluster, train a classifier to classify a datapoint as either inside or outside the group or cluster;
store each trained classifier and associate the stored trained classifier with the cluster or group's unique identifier;
for each new datapoint, use the new datapoint as input to each trained classifier and determine a most likely cluster or group to which the new datapoint is assigned;
assign a label to the new datapoint based on the identifier of the cluster or group to which the new datapoint is assigned; and
use a plurality of new datapoints and the new datapoints' assigned labels to train a machine learning model.

16. The one or more non-transitory computer-readable media of claim 15, wherein the real-valued representation for each datapoint in a dataset is generated by an embedding process.

17. The one or more non-transitory computer-readable media of claim 15, wherein the unique identifier is based on one or more attributes of a datapoint or datapoints in the cluster or group.

18. The one or more non-transitory computer-readable media of claim 15, wherein determining a most likely cluster or group to which the new datapoint should be assigned further comprises determining the cluster or group associated with the trained classifier having the highest level of certainty in its output.

19. The one or more non-transitory computer-readable media of claim 15, wherein the similarity between the generated representations is determined based on a metric, and further, wherein the metric is one of Manhattan distance, Euclidean distance, or Cosine distance.

20. The one or more non-transitory computer-readable media of clause 15, wherein instead of generating a real-valued representation for each datapoint in a dataset, a plurality of real-valued representations for each datapoint in a dataset are generated, and for each of the plurality of representations, the method proceeds as described.
